(19) United States
(12) Patent Application Publication
(10) Pub. No.: US 2019/0332000 A1
(43) Pub. Date: Oct. 31, 2019

(54) Projection Screen System

(71) Applicant: 4Panes, LLC, Holtsville, NY (US)

(72) Inventor: Andrew DeMeo, Holtsville, NY (US)

(21) Appl. No.: 16/388,109

(22) Filed: Apr. 18, 2019

Related U.S. Application Data
(60) Provisional application No. 62/662,316, filed on Apr. 25, 2018.

(51) Int. Cl. G03B 21/60; G03B 21/58; F16M 11/24

(52) U.S. Cl. CPC G03B 21/60; F16M 11/242; G03B 21/58

(57) ABSTRACT

A projection screen system includes a frame with a middle section, a first pivotable section hingedly connected to the first side of the middle section and a second pivotable section hingedly connected to the second side of the middle section such that the first and second pivotable section pivot relative to the middle section. A screen comprising a sheet of polyvinyl chloride is removably mountable to the frame. The screen has a planar shape when the frame sections are coplanar, and the shape of the screen changes from the planar shape to an arcuate shape when the first and second pivotable sections pivot at an angle relative to the middle section. In some cases, the frame and screen have corresponding strips of hook and loop fasteners by which the screen is mountable to the frame. In some cases, the frame includes mounting brackets that slide along it's horizontal beams.

### FIELD OF THE INVENTION

The present invention relates to a system for providing a projection screen. More specifically, the invention relates to a screen with a high-quality display that is large enough to simultaneously display imaging data from multiple sources and is easily assembled and adjusted by the user.

### BACKGROUND OF THE INVENTION

The TV set industry has and continues to attack its ongoing constraint—the weight-to-price equation. As a result, the industry is often characterized as having hit a wall with respect to screen size-to-price ratios. The commercial limitations of TV sets with viewing screens larger than 65″ continues to limit the investment and corporate interest in developing new home entertainment specially designed for viewing on screens larger than today's norm. At the same time, there continues to be more and more video and multimedia viewing options, and there is an ever-increasing opportunity to provide young adults accustomed to small screens with a large screen TV alternative.

Projectors permit viewing screens with real estate upwards of a hundred square feet in the same footprint as a conventional large screen TV set, at one tenth of the cost. This facilitates the integration of different video delivery platforms, information, and communication channels for simultaneous viewing on very large viewing screens.

Today's consumer is forced to toggle between multiple different viewing screens while watching video entertainment. These different screens were never intended to be viewed together. TV, movies, and video games are meant to be viewed from ten feet away, while computer screens are meant to be viewed from two feet away, and cell phone screens from ten inches away.

Additionally, home entertainment is consumed in a linear fashion by groups of people, with an entire group engaging in one activity, with one image source at a time. Moreover, picture-in-picture,” while widely available for free, is seldom used and has no specific content developed for it specifically as a secondary source.

However, home projectors and very large viewing screens make it possible to view multiple different viewing channels at the same distance on one screen without needing to contend for viewing screen real estate. Further, the ability to view multiple images at once without sacrifice to any image facilitates the provision of streaming video and data, gaming, and personal content that can be tailored for and by the consumer.

Therefore, the ability to use projectors in conjunction with very large viewing screens will usher in widespread use of projectors, facilitate the integration of multiple media sources for display on that screen, and encourage further development in the streaming industry for many different types of entertainment segments. Consumers will be able to watch live events (e.g., sports) and movies, play video games, search for information, and shop on the web, in a system that integrates broadcast channels, streaming channels, internet applications, social media, and Next Gen TV (ATSC 3.0), with control and choice like never before, all while significantly dropping the price of a home entertainment system.

However, the use of projectors with very large screens poses a number of challenges. For example, in the home, it is often undesirable to have such a large piece of equipment take up so much space on a permanent basis. Additionally, users of such large equipment often want to use it in a variety of venues on a temporary basis (such as for sporting events, concerts, trade shows, and countless other such activities). However, in order to do so, this usually either requires complicated, expensive equipment to support the screen and maintain it under tension (which typically cannot be quickly assembled, disassembled, and moved), or involves projection onto screens or surfaces that produce low quality displays.

What is desired, therefor, is a projection screen system that provides a very large, high quality display that is inexpensive. What is further desired is a projection screen system that is readily portable. What is also desired is a projection screen system that very easy to assemble and disassemble.

### SUMMARY OF THE INVENTION

Accordingly, it is an object of the present invention to provide a projection screen system that employs a screen material capable of displaying large projected images in high quality that is inexpensive.

It is also an object of the present invention to provide a projection screen system that is lightweight for easy transport but is sturdy when assembled.

It is a further object of the present invention to provide a projection screen system that can be assembled and disassembled without tools.

It is still another object of the present invention to provide a projection screen system that is freestanding and does not require any other supporting structures, can be adapted to irregular floor or ground surfaces, and does not require any mechanism for placing the screen under tension.

It is yet another object of the present invention to provide a projection screen system that enables the user to very easily level, center, and adjust the height of the screen.

It is still another object of the present invention to provide a projection screen system that enables the user to easily adjust the curvature of the screen to provide both two dimensional and three dimensional (“immersive”) viewing experiences.

In order to overcome the deficiencies of the prior art and to achieve at least some of the objects and advantages listed, the invention comprises a projection screen system, including a frame, the frame having a middle section with first and second sides, a first pivotable section hingedly connected to the first side of the middle section such that the first pivotable section pivots relative to the middle section, and a second pivotable section hingedly connected to the second side of the middle section such that the second pivotable section pivots relative to the middle section, a screen removably mountable to the frame, wherein the screen comprises a sheet of polyvinyl chloride, wherein the screen has a planar shape when the middle, first pivotable, and second pivotable sections of the frame are coplanar and the screen is mounted thereto, and wherein, when the middle, first pivotable, and second pivotable sections of the frame are coplanar and the screen is mounted thereto, the shape of the screen changes from the planar shape to an arcuate shape when the first and second pivotable sections pivot at an angle relative to the middle section.

In certain advantageous embodiments, the screen has a thickness between 30 mils and 60 mils.

In certain embodiments, the frame and the screen have corresponding strips of hook and loop fasteners by which the screen is mountable to the frame. In some of these embodiments, the system further includes a first and second extension beams each having a back and a front, wherein the first pivotable section and the back of the first extension beam have corresponding strips of hook and loop fasteners such the first extension beam is removably mountable to the first pivotable section, the second pivotable section and the back of the second extension beam have corresponding strips of hook and loop fasteners such the second extension beam is removably mountable to the second pivotable section, and the screen and the fronts of the first and second extension beams have corresponding hook and loop fasteners such that the screen is removably mountable to the first and second extension beams.

In some embodiments, the middle section, first pivotable section, and second pivotable section comprise plastic. In other embodiments, the middle section, first pivotable section, and second pivotable section comprise polyvinyl chloride.

In certain advantageous embodiments, each of the first and second pivotable sections of the frame includes a horizontal section, the frame further comprises a plurality of mounting brackets each having a cavity that accommodates at least a portion of at least one of the horizontal sections such that the mounting bracket is slidable along the horizontal section when the mounting bracket is disposed thereon, and the screen is mounted to the frame via the plurality of mounting brackets, such that the screen is horizontally slidable relative to the frame when mounted thereto via the plurality of mounting brackets. In some cases, the screen and the plurality of brackets have corresponding strips of hook and loop fasteners by which the screen is mountable to the plurality of brackets.

In certain embodiments, the first pivotable section of the frame includes an upper horizontal beam and a lower horizontal beam, and the frame further comprises a first plurality of mounting brackets each having a cavity that accommodates at least a portion of the upper or lower horizontal beam of the first pivotable section such that the first plurality of mounting brackets are slidable along the upper or lower horizontal beams of the first pivotable section when the first plurality of mounting brackets are disposed thereon. The second pivotable section of the frame includes an upper horizontal beam and a lower horizontal beam, and the frame further comprises a second plurality of mounting brackets each having a cavity that accommodates at least a portion of the upper or lower horizontal beam of the second pivotable section such that the second plurality of mounting brackets are slidable along the upper or lower horizontal beams of the second pivotable section when the second plurality of mounting brackets are disposed thereon. The middle section of the frame includes an upper horizontal beam and a lower horizontal beam, and the frame further comprises a third plurality of mounting brackets each having a cavity that accommodates at least a portion of the upper or lower horizontal beam of the middle section such that the third plurality of mounting brackets are slidable along the upper or lower horizontal beams of the third pivotable section when the third plurality of mounting brackets are disposed thereon. The screen is mounted to the frame via the first, second, and third pluralities of mounting brackets, such that the screen is horizontally slidable relative to the frame when mounted thereto via the first, second, and third pluralities of mounting brackets.

In some embodiments, the system further includes first and second tripods mounted to the first and second sides of the middle section, respectively, for supporting the frame above a horizontal surface, the first and second tripods each having collapsible legs. In some cases, each of the first and second tripods includes a vertical member by which the first and second tripods are mounted to the middle section, the vertical member being vertically extendable relative to the legs. In some of these embodiments, the vertical members of the first and second tripods are removably mounted to the middle section.

In certain advantageous embodiments, the system further includes a plurality of mounting beams for mounting the frame to a wall.

In certain embodiments, each of the middle, first pivotable, and second pivotable sections of the frame comprises two horizontal beams and two vertical beams, wherein each of the horizontal beams is connected to each vertical beam via a lap joint. In other cases, each of the middle, first pivotable, and second pivotable sections of the frame comprises two horizontal beams and two vertical beams, wherein each end of the horizontal beams includes a protuberance, and each end of the vertical beams includes a recess for accommodating one of the protuberances. In yet other cases, each of the middle, first pivotable, and second pivotable sections of the frame comprises two horizontal beams and two vertical beams, and the system further includes a plurality of corner connectors each having perpendicular protuberances, wherein each end of the horizontal and vertical beams includes a recess for accommodating one of the protuberances of the corner connectors.

In some embodiments, the system further includes a reversible bracket having a first side and a second side, wherein the middle, first pivotable, and second pivotable sections of the frame each has a front face and a rear face, and the screen is removably mountable to the front faces of the middle, first pivotable, and second pivotable sections of the frame. The first side of the reversible bracket is substantially flat, such that when the first side of the reversible bracket is attached to the rear face of the middle section and the rear face of one of the first and second pivotable sections, the reversible bracket retains the sections attached thereto in a coplanar alignment. The second side of the reversible bracket has a first portion and a second portion angularly offset from the first portion, such that, when the second side of the reversible bracket is attached to the rear face of the middle section and the rear face of one of the first and second pivotable sections, the reversible bracket retains the pivotable section attached thereto at an angle relative to the middle section.

In certain advantageous embodiments, the system further includes an elongated retaining bracket removably attachable to the frame, wherein the middle, first pivotable, and second pivotable sections of the frame each has a front face and a rear face, and the screen is removably mountable to the front faces of the middle, first pivotable, and second pivotable sections of the frame. The at least one elongated retaining bracket and the tops of the rear faces of the middle, first pivotable, and second pivotable sections of the frame have corresponding hook and loop fasteners by which the at least one elongated retaining bracket is attached to the middle, first pivotable, and second pivotable sections such that, when the at least one elongated retaining bracket is attached to the middle, first pivotable, and second pivotable sections, the elongated retaining bracket retains the middle, first pivotable, and second pivotable sections in a coplanar alignment.

In certain embodiments, the system further includes a projector for projecting images on the screen. In some of these embodiments, the system also includes a multiviewer that receives data from a plurality of input sources, processes the data, and transmits the data to the projector for simultaneous projection of images reflecting data from the plurality of input sources.

### BRIEF DESCRIPTION OF THE DRAWINGS

FIG. 1A is a front perspective view of a frame and screen assembly in accordance with the invention.

FIG. 1B is a rear perspective view of one embodiment of the frame and screen system of FIG. 1A.

FIG. 2 is a perspective view of the frame of FIG. 1B folded into a collapsed state.

FIG. 3 is a rear perspective view of the coupling assemblies of the tripods of FIGS. 1B.

FIGS. 4A-C are perspective views of beam systems forming the sections of the frame of FIG. 1B.

FIG. 5 is a front perspective view of corresponding hook and loop fasteners on the screen and frame of FIGS. 1A-B.

FIG. 6 is a perspective view of the frame of FIG. 1A employing extension beams.

FIG. 7A is a perspective view of the mounting brackets of FIG. 1B.

FIG. 7B is a perspective view of the mounting bracket of FIG. 7A on a beam.

FIGS. 7C-D are perspective view of the operation of the sliding bracket of FIG. 7B when a frame section is pivoted.

FIG. 8A is a perspective view of a mounting bracket used with the frame of FIG. 1B.

FIG. 8B is a perspective view of the mounting bracket of FIG. 8A attached to the frame when the frame sections are coplanar.

FIG. 8C is a perspective view of the mounting bracket of FIG. 8A attached to the frame when the frame sections are not coplanar.

FIG. 9A is a front perspective view of elongated retaining brackets mountable to the frame when the frame sections are coplanar.

FIG. 9B is a rear perspective view showing a portion of the elongated retaining bracket of FIG. 9A mounted to the frame.

FIGS. 10A is perspective view of an assembly for mounting the screen of FIG. 1A to a wall.

FIG. 10B is a perspective view of the assembly of FIG. 10A showing the curving of a screen edge.

FIG. 11 is a schematic view of the projection screen system of FIG. 1A.

FIG. 12A-B are schematic views of the components of the multi-viewer device of FIG. 11.

### DETAILED DESCRIPTION OF THE INVENTION

The following detailed description illustrates the technology by way of example, not by way of limitation, of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

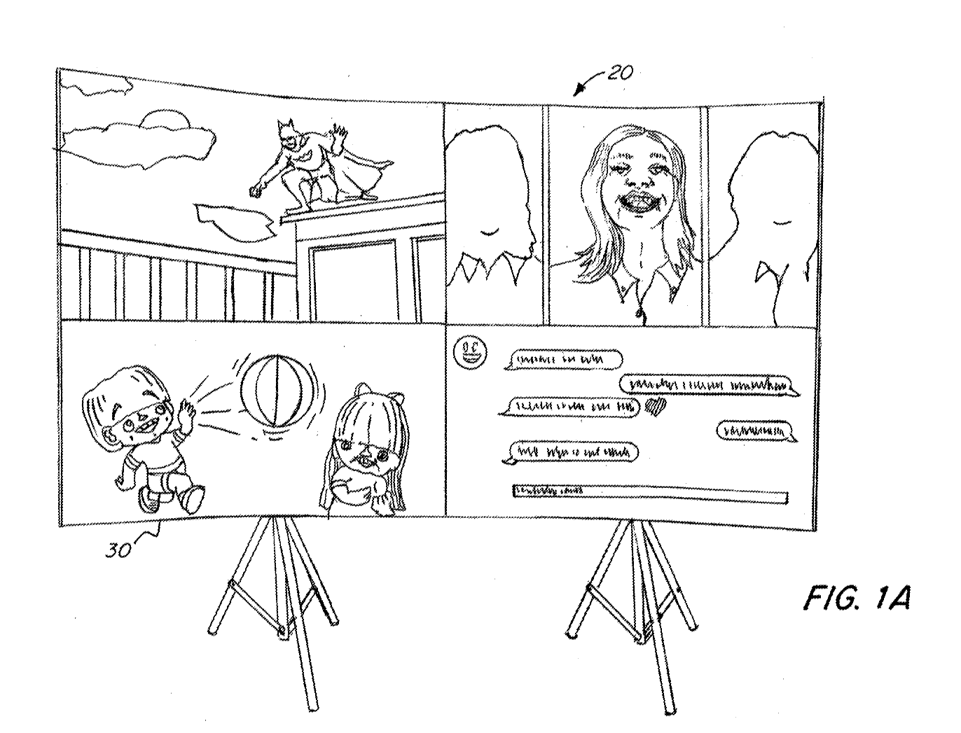

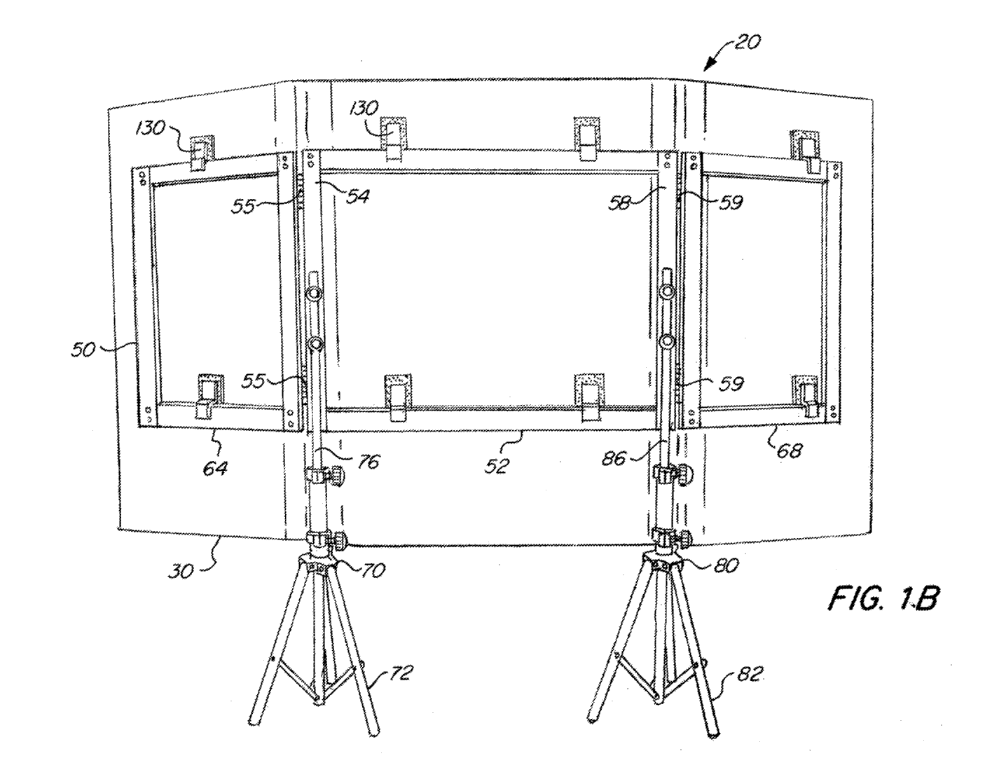

FIGS. 1A-B illustrate one exemplary embodiment of a projection screen system (20) in accordance with the invention. The system (20) includes a projection screen (30) for receiving images projected by a projector. The screen is removably mounted to a frame (50), as is described in further detail below.

The screen (30) is comprised of a rigid sheet of polyvinyl chloride (PVC) that is larger than a conventional screen. In certain advantageous embodiments, the screen (30) is approximately five and a half feet wide. However, depending on the use, other particular sizes that provide a sufficiently large screen area may be used. Generally, the screen will be at least four feet high. Likewise, the screen will generally be at least four feet long, but will usually be longer.

The screen (30) is fashioned from a PVC sheet that is an appropriate thickness to make the screen rigid enough to self-maintain a fully expanded state when hung or laid flat (i.e., when not under tension), yet flexible enough to be rolled up and placed in a carrying tube for easy transport and/or storage. In certain advantageous embodiments, the screen (30) comprises a PVC sheet that has a thickness between 30 mils and 60 mils. In particularly advantageous embodiments, the sheet thickness is 40 mils. By employing a sheet of polyvinyl chloride of such an appropriate thickness, one is able to provide a material that can be assembled into a very large projection screen, where the material is not heavy or cumbersome (and therefore, can be easily moved to the desired location), yet can also be very easily assembled without the need for complex apparatus or installation procedures necessary to stretch and place the material under tension.

As illustrated in FIG. 1B, the frame (50) to which the screen (30) is mounted is easily assembled and disassembled, as described in further detail below. The frame (50) includes a long middle section (52), as well as shorter pivotable sections (64, 68). The first pivotable section (64) is hingedly connected to the first side (54) of the middle section (52) via a plurality of hinges (55), and a second pivotable section (68) is hingedly connected to the second side (58) of the middle section (52) via a plurality of hinges (59). For example, standard 3.5 inch by 3.5 inch door hinges can be used for this purpose.

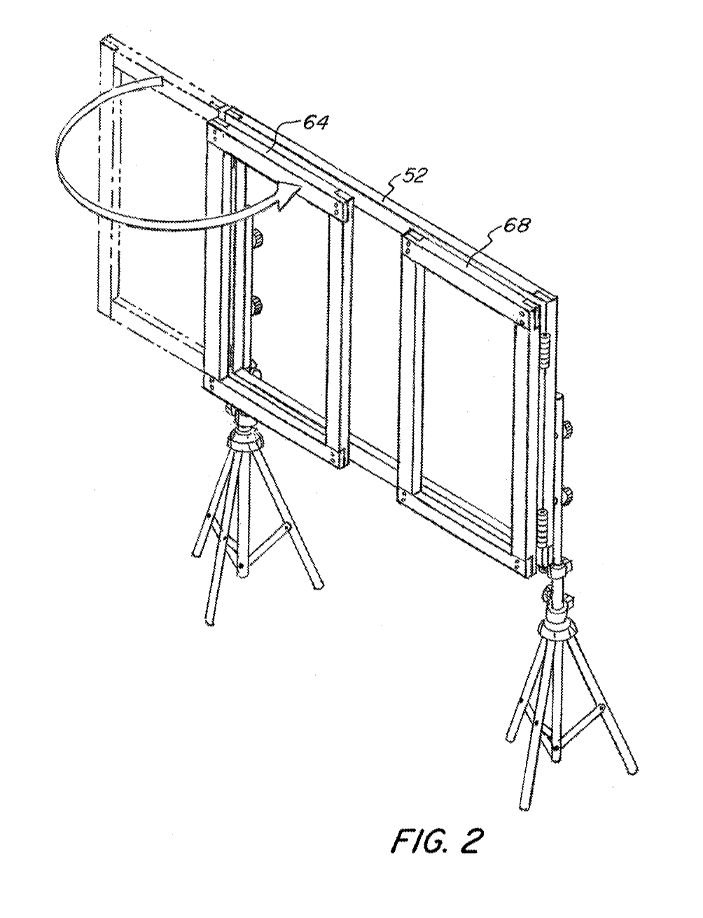

The frame (50), which is illustrated in an unassembled state without the screen (30) in FIG. 2, can be stored and/or transported in the shown collapsed position, in which the first and second pivotable sections (64, 68) are folded in against the middle section (52). When assembled, the first and second pivotable sections (64, 68) can be pivoted relative to the middle section (52) about the hinges (55, 59) to a desired position. If a flat projection screen is desired, the first and second pivotable sections (64, 68) can be pivoted until they are coplanar with the middle section (52). If a curved projection screen is desired, such as for the purpose of creating an immersive viewing experience as further described below, the first and second pivotable sections (64, 68) can pivoted such that they sit at an angle relative to the middle section (52), as shown in FIG. 1B.

The system (20) further includes first and second tripods (70, 80) that support the frame sections (52, 64, 68) above a horizontal surface, such as a floor, stage, ground, or other structure on which it is desired to assemble a projection screen. The tripods (70, 80) each have gradually collapsible legs (72, 82), such that they can be easily moved and stored. Additionally, the collapsible legs (72, 82) allow the assembler to adjust the vertical height of the legs by collapsing them to various degrees. This further allows the assembler to collapse legs (72) to a different degree than legs (82) in cases where the projection screen is being assembled on an uneven surface.

Each of the tripods (70, 80) also has a vertical member (76, 86). The first side (54) of the middle section (52) is mounted to the vertical member (76), and the second side (58) of the middle section (52) is mounted to the vertical member (86). In this way, the tripods (70, 80) support all three frame sections (52, 64, 68). The vertical members (76, 86) are vertically extendable relative to the collapsible legs (72, 82) of the tripods, such that the height of the screen (30) mounted to the (50) can be adjusted as desired. Additionally, the vertical member (76) can be adjusted to a different height than the vertical member (86) in order to accommodate uneven floor or ground surfaces.

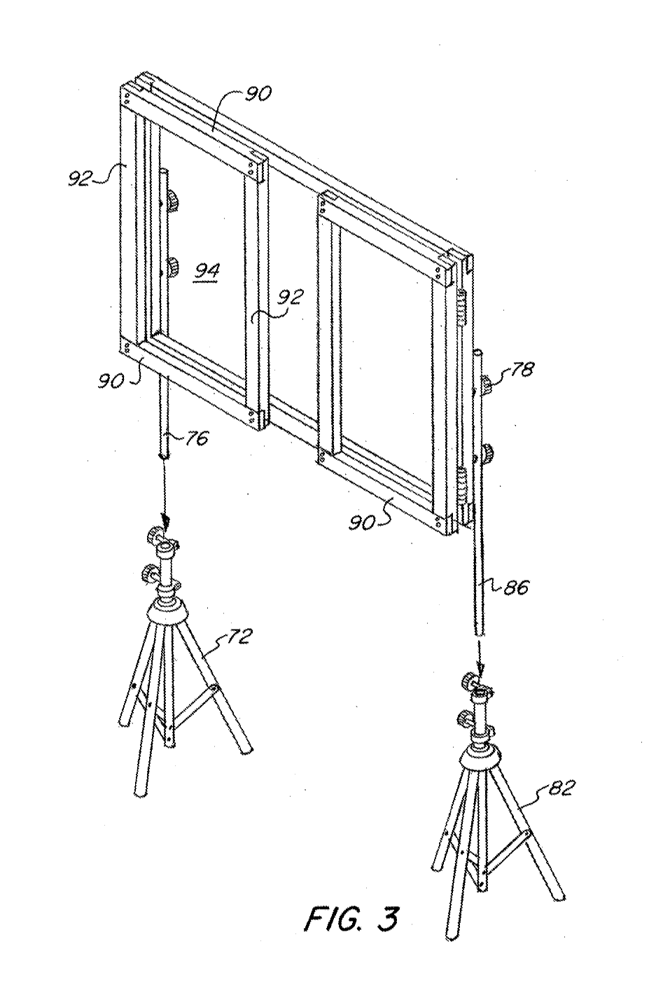

As shown in FIG. 3, in some embodiments, each vertical member (76) is removably mounted to the middle section (52), such as via bolts extending through the frame section (52) and vertical member (76), and secured with fasteners (78). These may be, for example, wing nuts, and optionally a spacer (79) between the frame (52) and vertical member (76), or similar removable fasteners may be employed, such as, for example, threaded knobs inserted through the vertical member (76) and into threaded recesses in the frame section (52). As also illustrated in FIG. 3, in some embodiments, each vertical member (76) is also removably coupled to the rest of the tripod (70), thereby allowing the frame (50) to be detached from the legs (72) without detaching the vertical member (76) from the frame. By employing multiple types of such removable couplings at different parts of the assembly, the ease of assembling and disassembling the system (20) can be even further increased.

Though the tripod assemblies described above provide a number of advantages, it should be noted that, alternatively, the frame (50) may be mounted to a wall, as further described below.

The frame sections (52, 64, 68) can each be assembled via various methods. The frame sections (52, 64, 68) may be made of any suitable material, such as wood, metal, or plastic, but which preferably comprises a material that is both sturdy and lightweight. Each of the sections (52, 64, 68) is preferably in the form of a frame with two horizontal sections (90), two vertical sections (92), and a hollow center (94) in order to reduce the weight of the overall frame (50).

In certain advantageous embodiments, these frame sections (52, 64, 68) are made of two horizontal beams (90) and two vertical beams (92) of plastic, which provides sufficient sturdiness, but is still lightweight enough to be easily portable. In other embodiments, the beams comprise PVC extrusions, which provide the same advantages. In still other embodiments, the beams comprise medium-density fibreboard (MDF) or aluminum. In some embodiments, the beams are secured to each other with bolts and wingnuts or the like to enable each of the sections (52, 64, 68) themselves to be easily disassembled and reassembled, if desired.

In advantageous embodiments, each of the beams (90, 92) is between a half inch and one inch thick, between one and a half inches and two and half inches wide, and between two and five feet long. Typically, the horizontal beam of the middle section (52) is longer than the horizontal beams of the first and second pivotable sections (64, 68).

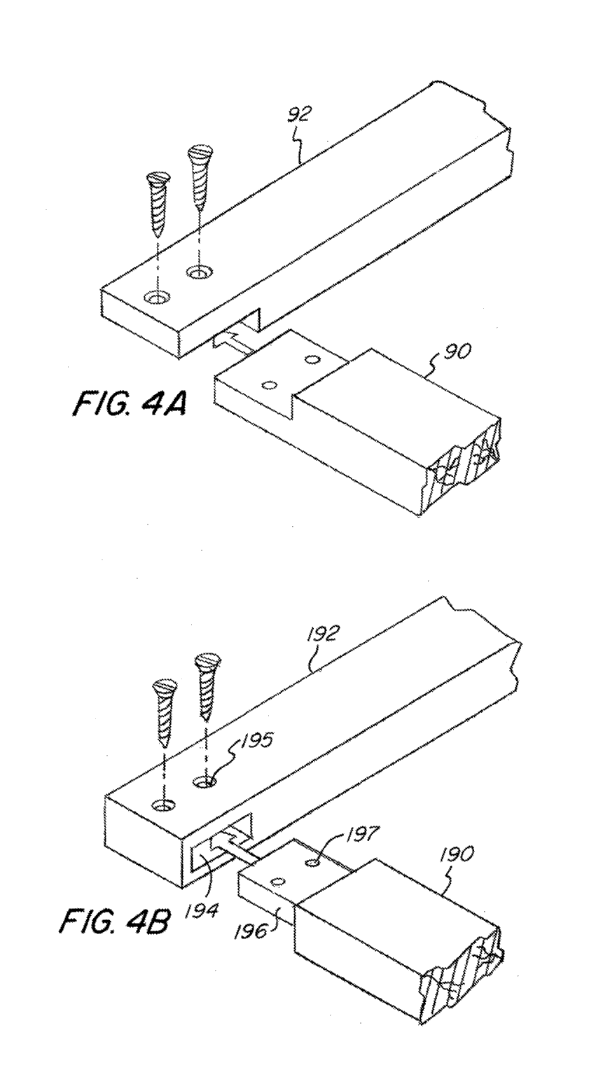

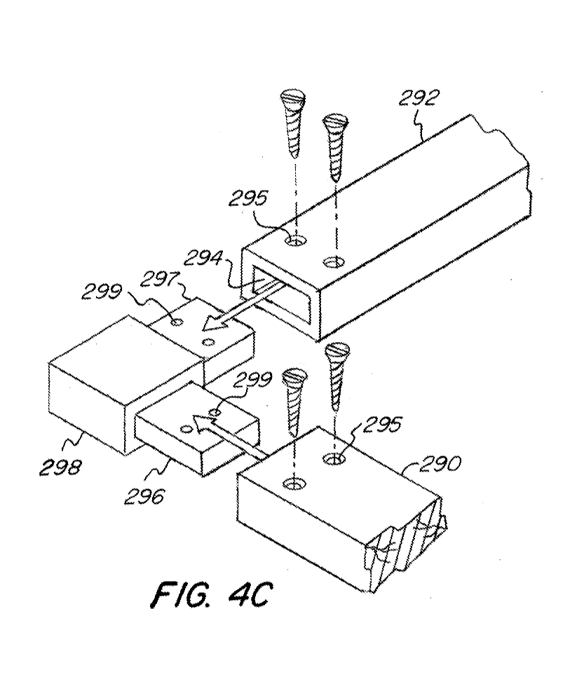

As shown in FIG. 4A, in certain embodiments, the horizontal beams (90) and vertical beams (92) are joined together via lap joints and secured with bolts.

As shown in FIG. 4B, in other embodiments, the vertical beams (192) each have a recess (194) adjacent the top and the bottom thereof that accommodates a corresponding protuberance (196) extending from the end of the horizontal beams (190). When the protuberance (196) is fit into the recess (194), apertures (195) of the vertical beam (192) align with apertures (197) of protuberance (196), and fasteners (such as bolts) are inserted therethrough to secure the beams (190) to beam (192). This type of connection is especially useful in cases where the beams (190, 192) are made of PVC.

As shown in FIG. 4C, in still other embodiments, the horizontal beams (290) and vertical beams (292) each have recesses (294) at both ends thereof. A separate corner connector (298) has protuberances (296, 297) which fit into the recesses (294), and when the apertures (299) of the corner connector (298) align with the apertures (295) of the horizontal and vertical beams (290, 292), bolts are inserted therethrough to secure the beams (290, 292) to the corner connector (298). Again, this type of connection is especially useful in cases where the beams (290, 292) are made of PVC.

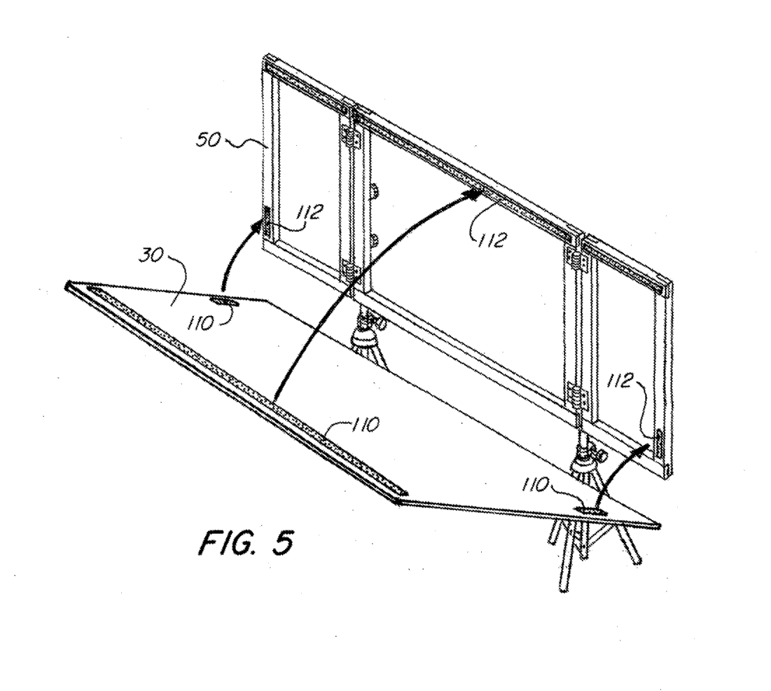

Referring to FIG. 5, in certain advantageous embodiments, the back of the screen (30) and the front of the frame (50) have corresponding hook and loop fastener (e.g., Velcro®) strips (110, 112) with which one can easily mount the screen (30) to the frame (50), such the screen can easily be removed from the frame (50), either to adjust its position and to disassemble the projection screen system (20).

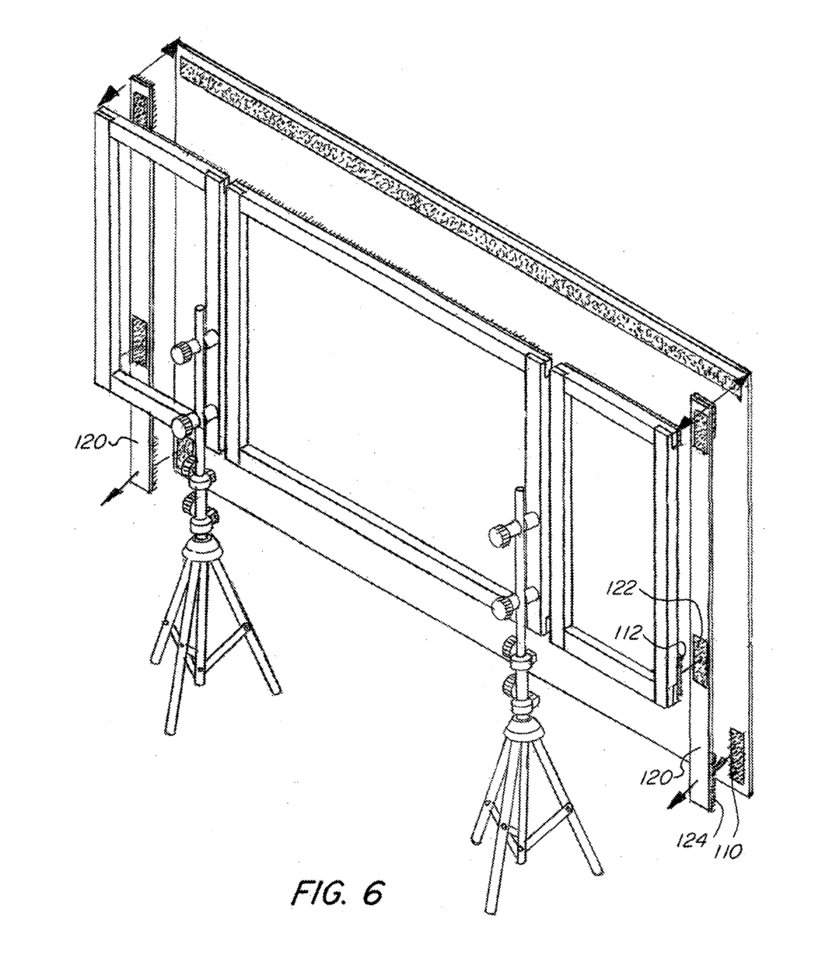

As shown in FIG. 6, in certain advantageous embodiments, the system (20) also includes an extension beam (120) for each side of the frame (50). The extension beam (120) includes hook and loop fastener strips (122, 124) on the two sides thereof, such that the strip (122) on the back of the beam (120) can attach the extension beam (120) to the hook and loop fastener strip (112) on the first pivotable frame section (64), while the strip (124) on the front of the beam (120) can attach the extension beam (120) to the hook and loop fastener strip (110) on the back of the screen (30).

In other embodiments, the first and second pivotable sections (64, 68) simply extend vertically farther than the middle section (52). However, by instead using the above-described extension beam (120), the overall weight of the frame (50) is reduced, while the versatility of the frame is increased by allowing the assembler to use a greater variety of screen sizes by either attaching or not attaching the beam (120).

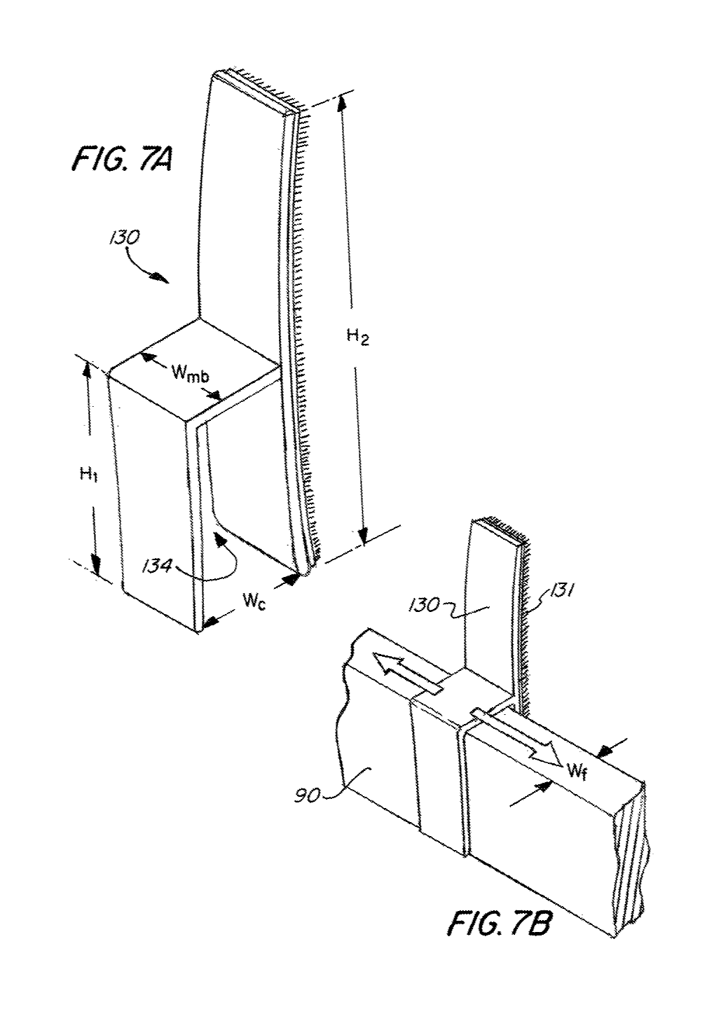

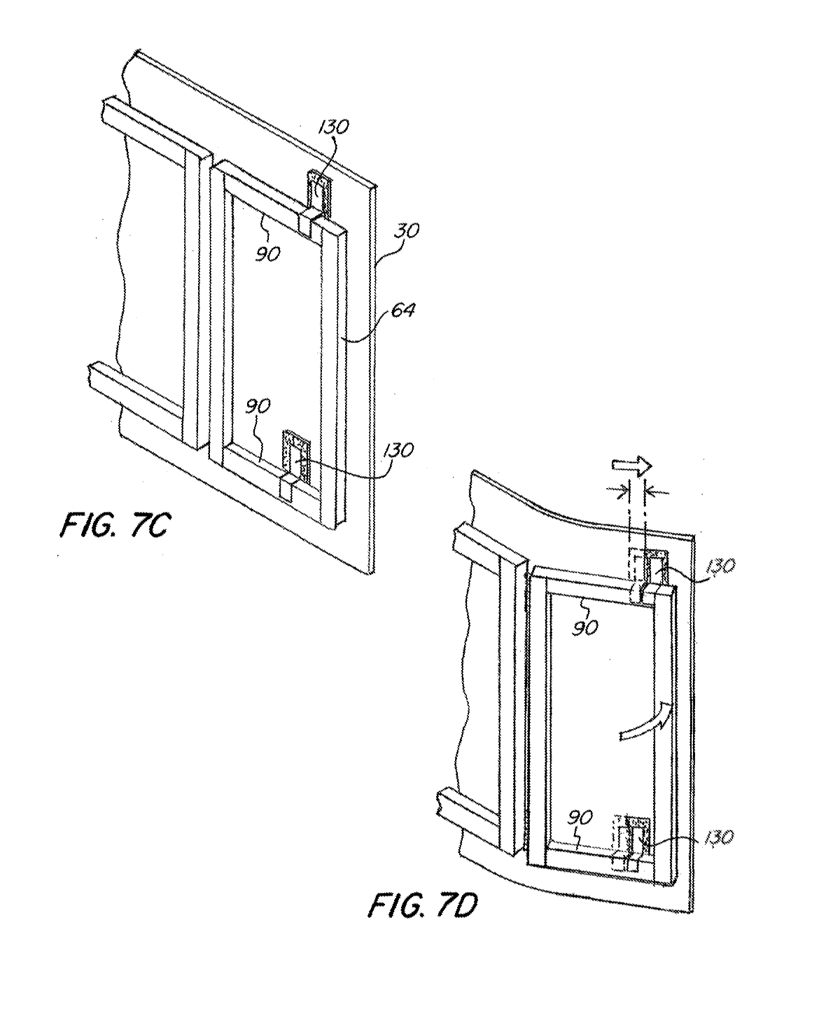

In certain advantageous embodiments, the frame (50) further includes mounting brackets (130) with which the screen (30) is mounted to the frame (50). In the example illustrated in FIG. 7A, the mounting bracket has the general shape of a lowercase h, with a short height H₁ of two and a half inches, a long height H₂ of six inches, and width W_{mb} of two inches.

The mounting bracket (130) has a cavity (134) with a width W_{c} slightly larger than the width W_{f} of the horizontal beams (90) of the frame sections (52, 64, 68) such that the cavity (134) can accommodates a beam (90), as illustrated in FIG. 7B. For example, in one embodiment, the horizontal beam (90) has a width W_{f} of ¾ of an inch, and the bracket cavity (134) has a width W_{c} of ⅞ of an inch, such that the mounting bracket (130) fits over the horizontal beam.

The screen (30) is mounted to the mounting brackets (130) via a fastening system. As noted above, in advantageous embodiments, the fastening system comprises corresponding strips of hook and loop fasteners (110, 131) on the back of the screen (30) and mounting brackets (130). The use of elongated strips allows further variability in the exact height at which the screen (30) is attached to the frame (50). Additionally, the screen can be easily leveled by removing the screen (30) from the mounting clamp (130) that is sitting on the frame (50), leveling the screen, and then reattaching the screen (30) to the mounting clamp (130) at the desired screen height.

As shown in FIGS. 7C-D, the mounting clamps (130) slide along the beams (90) on which they sit, such that a user can pivot the angle of the first and second pivotable frame sections (64, 68) while the screen (30) is mounted thereto. In this way, the user is able to easily adjust the curvature of the screen (30) already mounted to the frame (50).

In the embodiment illustrated in FIG. 1B, it can be seen that one mounting clamp (130) is seated on each of the top and bottom horizontal beams (90) of each of the first and second pivotable frame sections (64, 68), and two mounting brackets (130) are seated on each of the top and bottom horizontal beams (90) of the middle frame segment (52). However, a different number of mounting brackets may be employed, depending on the specific size of the frame (50) and screen (30), as well as the particular screen curvature desired. When the screen (30) is fully mounted to the frame (50) via slidable brackets (130) in this way, one is also able to easily center it or otherwise adjust its position by simply gripping one edge of it and sliding the entire screen (30) left or right.

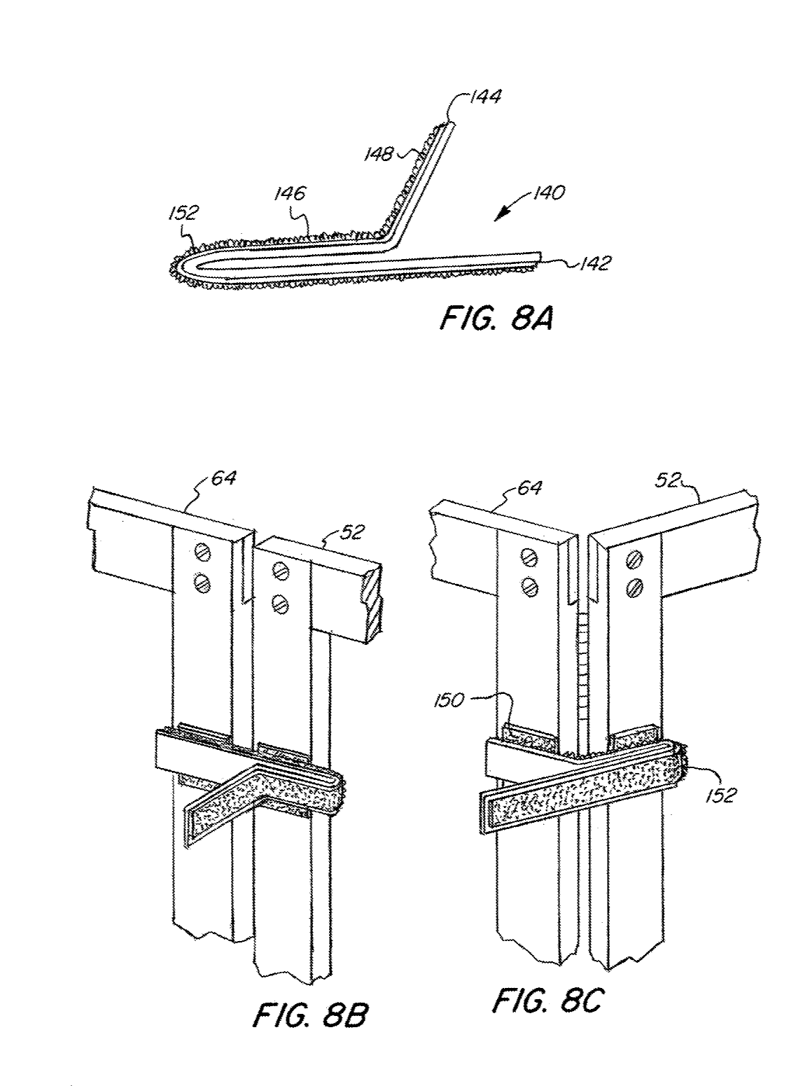

In some embodiments, the system (20) further includes reversible brackets (140) for retaining the first and second pivotable sections (64, 68) in a certain orientation relative to the middle section (52). As shown in FIG. 8A, the bracket (140) includes a first side (142) and a second side (144). The first side (142) is substantially flat, while the second side (144) has a first portion (146) and a second portion (148) that is angularly offset from the first portion (146).

The middle, first pivotable, and second pivotable sections (52, 64, 68) of the frame (50) each has a front face (to which the screen is mounted) and a rear face. The rear faces of the frame sections (52, 64, 68) and the first and second sides (142, 144) of the bracket have corresponding hook and loop fastener strips (150, 152), with which either side (142, 144) of the reversible bracket (140) can be attached to the frame sections (52, 64, 68).

Referring to FIG. 8B, when the first or second pivotable frame section (64, 68) is coplanar with the middle section (52), the first side (142) of the reversible bracket is attached to the rear face of the middle section (52) and the rear face of the coplanar pivotable section (64) so that the bracket (140) retains those sections in a coplanar alignment. As shown in FIG. 8C, if it is desired to pivot the pivotable section (64) to an angle relative to the middle section (52), the reversible bracket (140) is removed, the pivotable section is pivoted, and the second side (144) of the bracket is attached to frame, the first portion (146) attaching to the middle frame section (52), and the second portion (148) attaching to the pivoted section (64), such that the bracket (140) retains the pivoted frame section (64) at an angle relative to the middle section (52).

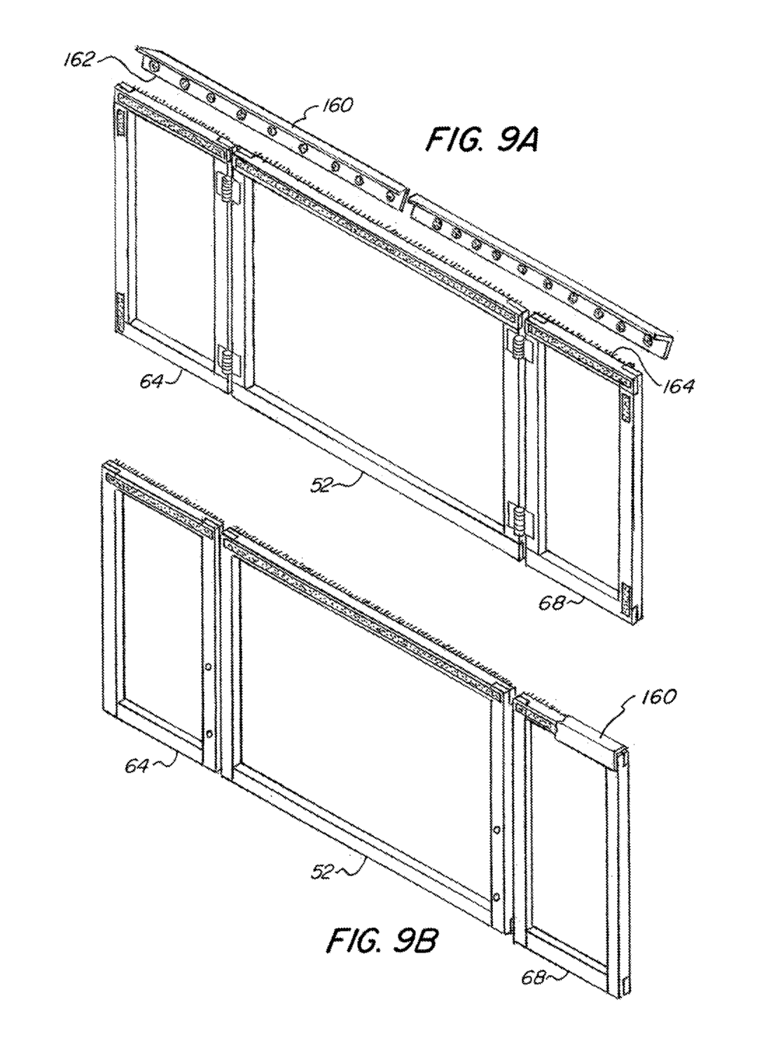

In some embodiments, the system (20) includes at least one elongated retaining bracket removably attachable to the frame (50) for use when it is desired to keep the frame sections (52, 64, 68) in a coplanar alignment. Referring to FIGS. 9A-B, this may include one or more elongated brackets (160) that extend along the top of the frame sections (52, 64, 68). The one or more elongated brackets (160) and the tops of the rear faces of the middle, first pivotable, and second pivotable frame sections (52, 64, 68) have corresponding hook and loop fasteners (162, 164) by which the one or more elongated brackets (160) are removably attached to the middle, first pivotable, and second pivotable frame sections (52, 64, 68). As a result, the elongated retaining bracket (160) prevents the middle, first pivotable, and second pivotable sections (52, 64, 68) from moving out of coplanar alignment.

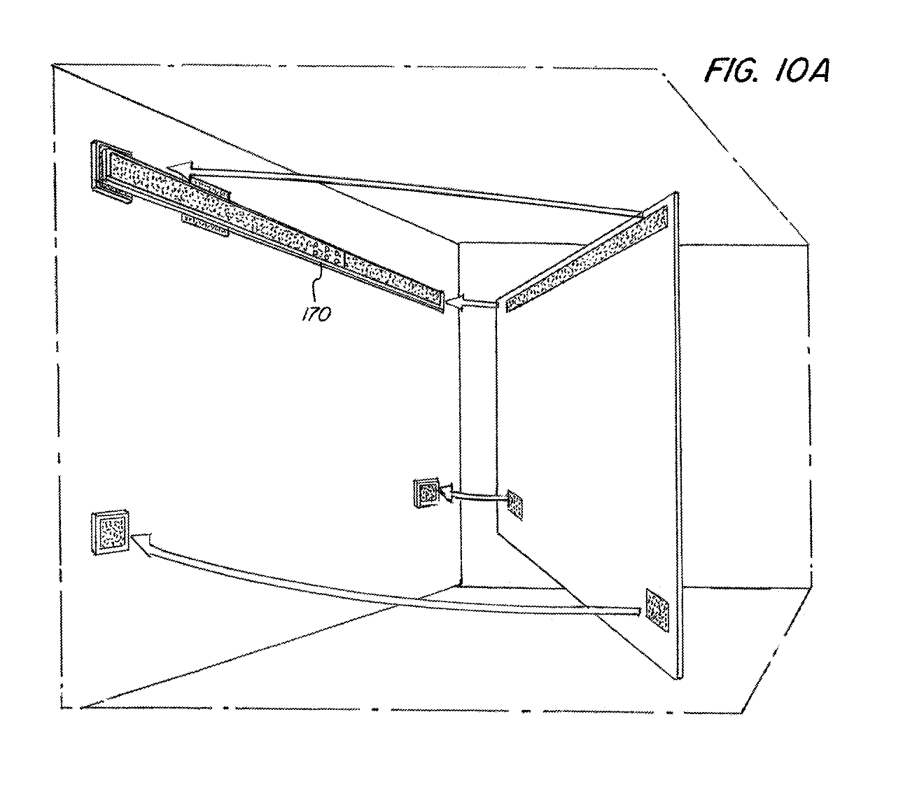

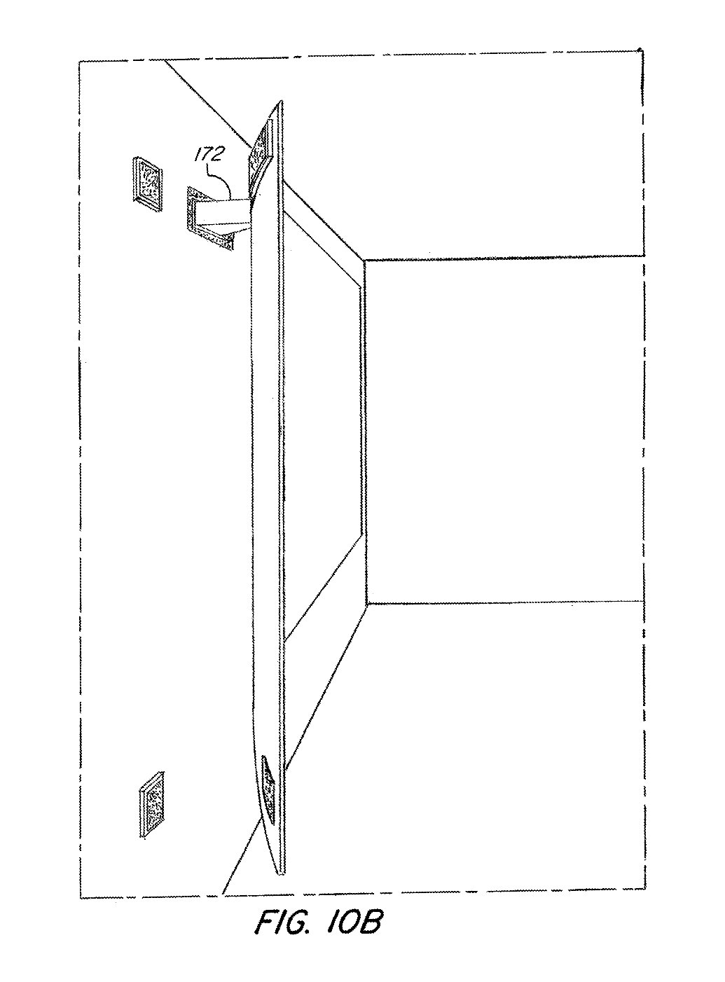

As shown FIGS. 10A-B, in a different embodiment, a mounting beam (170) may be provided for mounting the screen (30) to a wall. The beam may comprise multiple beams (170), and spacers (172) may be employed to curve the left and right sides of the screen (30).

Using this screen assembly, one can integrate, for example, up to four video/data feeds and enable the viewer to display these sources onto a single screen in multiple size combinations. The ability to assign, position, and move the display of individual video sources on the viewing screen is possible through simple push button commands, as further explained below. A wide range of video signals via a variety of different ports can be input, which are then able to be mapped to the screen in a variety of combinations and sizes.

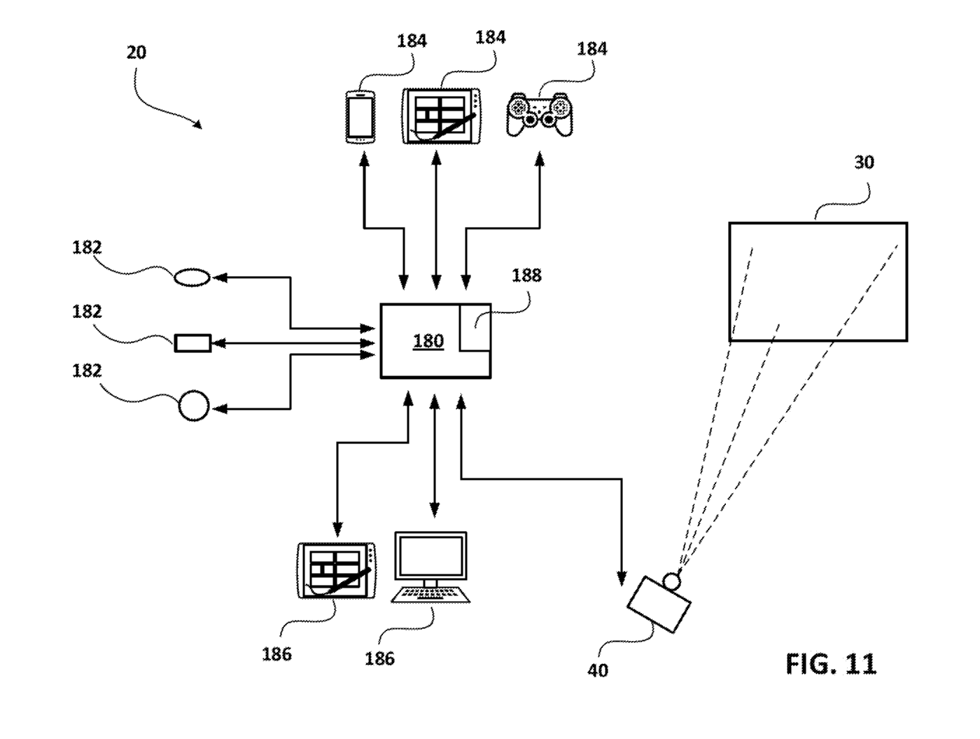

This integration of multiple video/data inputs for simultaneous display is managed by a multiviewer (180), as shown in FIG. 11. This multiviewer (180) receives video/data/object audio from various input sources (182), described in greater detail below, and may receive commands from various orchestration devices (184). The multiviewer (180) processes and manages the output of the video to the projector (40), which then displays it on the screen (30). Optionally, the multi-viewer device can also output video/data to one or more auxiliary devices (186). In some cases, the multiviewer (180) has its own interface (188) for manually inputting commands, such as tactile buttons or a graphical user interface for making input, output, format, and other selections, as is further described below.

The multi-viewer device will enable viewers to select entertainment sources from any input (182) and assign these sources to screen regions (boxes) via a mix of hard ports and wireless soft hub. Video feeds from a cable box, OTT provider specific applications, web-based streams or files, along with other data, Next Gen TV (ATSC 3.0), graphics and video feeds from other sources (gaming consoles, firesticks, PCs, phones, etc.) are seamlessly integrated for simultaneous viewing, as shown in FIG. 1A. Viewers can easily assign sources to viewing boxes in a source assignment template and orchestrate the template to change the size and placement of sources on the screen in real time or replace a source with a different source all together. The multiviewer software can be installed in cable boxes, satellite dishes, projectors or streaming devices to enable any TV consumer to have access to the new services.

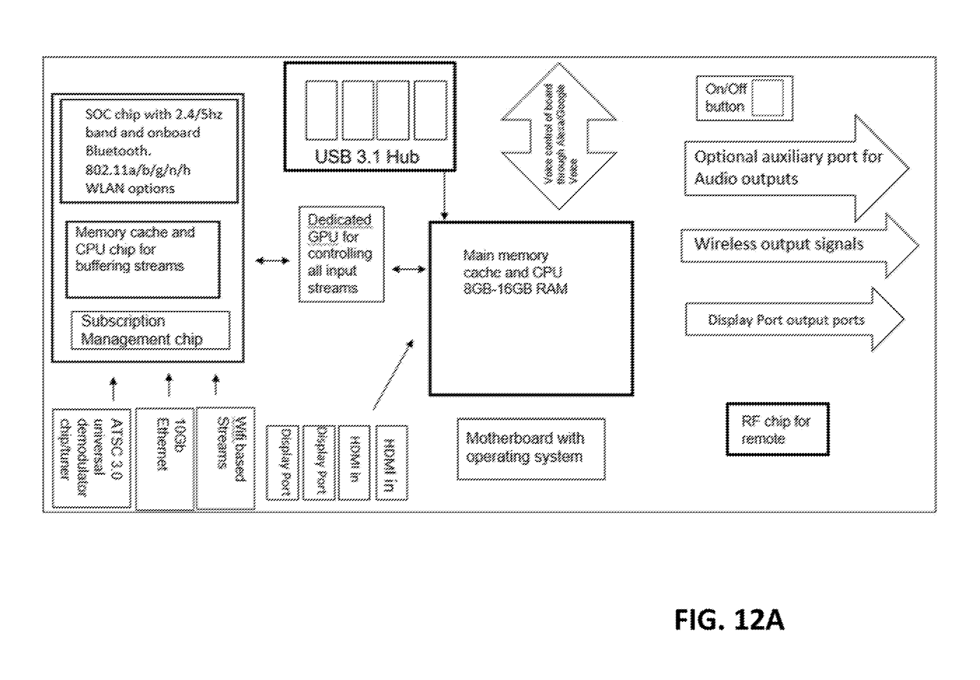

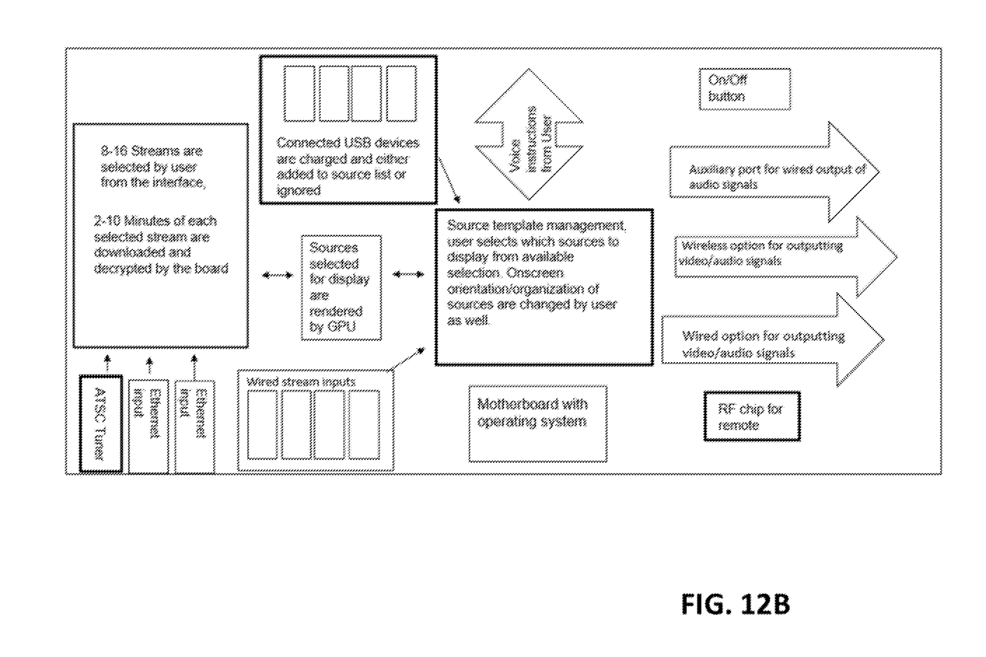

The basic components of the multi-viewer device (180) are represented schematically in FIGS. 12A-B. Starting at the left of the schematic, the multi-media device shakes hands with a relevant router, such that multiple streams enter the device via various sources (internet, cable, or satellite). A stream buffering board buffers the many data streams to keep them live so that there is no need to reach back out to the router when the user switches the input feeds. A temporary memory caches these streams, and a subscription management board manages information (e.g., logins) for subscription video providers (e.g., Netflix®, Hulu®, etc.). Source assignment software determines which of the potentially many incoming video feeds are assigned to the video cards.

The multi-viewer device includes a number of ports, such as USB and HDMI ports, for receiving other video feed inputs, such as gaming systems (e.g., Xbox®, PlayStation®), streaming TV players (e.g., Apple TV®, firestick, Roku®), computers, tablets, receivers, DVD players, etc. The ATSC 3.0 object manages the conversion of signals if required, or passes through signals for assignment to the stream buffer object.

A source to template management object controls which of the many inputs will be assigned to the allocated “boxes” on the screen. A template management object stores the templates used (e.g., six boxes vs. four boxes), and a screen orchestration object controls the display of the boxes, such as using split screen or full screen, or moving the different boxes around on the screen.

As a result of this integration, the user is able to engage in the various different activities separately or simultaneously.

For example, video game players can play their favorite video games in a complete 180 degree immersive, 4k environment with new functionality and environments that accentuates the immersive experience. Additionally, when put in the appropriate mode, two or four friends can play together on one screen to participate is duo or squad gaming using the segmented screen boxes that are enabled by the multiviewer and the extra large screen.

As another example, sports fans can watch multiple events at once without missing any of the action with multi-viewer software to seamlessly orchestrate the screens, can monitor the progress of their fantasy league matches with visual presentations never before possible, connect with friends in 4K video on Facetime, Facebook, and Snapchat with larger than life images, and experience the freedom of controlling the viewing action and selecting only the elements of a broadcast they like.

The modern-day home entertainment user can multitask while watching TV, movies, or live events. For example, they can monitor fantasy leagues matches or manage a team roster, connect with friends via texting, video calls (e.g., Facetime, Skype, and web video conferencing), and social media (e.g., Instagram, Snapchat, Facebook), connect with others via Twitter, Group chats, blogs, watch multiple channels, play video games, shop online, and listen to music, all of which can be done simultaneously using the large screen and segmented displays enabled by the multiviewer.

With the system described herein, different forms of video media are able to be provided in new and better ways, examples of which include live sporting events with multiple new and existing camera angles, selectable by the viewer, computer games that take advantage of the new immerse, multi-screen environment. (e.g., change aspect ratios of player to environment and consider true four-man squad gaming in same room as the norm), cinema that leverages the immersive 4k screen system, and existing content re-mastered in 4k for large screen viewing.

Numerous types of industry-specific benefits are borne from the above described platform, including that content providers of live TV events will be able to provide and charge for multiple camera angles packaged for viewers to select from, new services will develop that integrate data services and personal video services into broadcast services for part of the viewing experience, existing classic content can be repackaged with multiple camera angles for viewers to select from and display at the same time as the images presented in the original production presentation, and new cinema will develop that is based on being able to present multi images in an immersive environment.

The above described system also permits numerous other new ways to combine multiple activities. This includes integrating “narrowcast” and computer-based services in ways not previously possible by permitting viewers to do the things they do on their phone/computer while watching TV, but now on very big screens with new capabilities. Snapchat becomes “Fanchat,” enabling fans to watch feeds from their friends and family phone's camera during the event on one of the screens. Phone services like texting can be integrated and orchestrated with large fonts on one of the screens as well. Twitter becomes “Banter”, enabling bantering with NFL players on a “groupcast” forum and presented on a portion of one of the screens reacting in real time to the play to those fans that joined that particular “groupcast.”

The system also allows movie and television producers to direct and conceptualize their presentation to the viewer in new ways due to a true immersive environment for new camera angles on a canvas that is significantly larger than traditional television, and leverage 4k technology to bring the action and drama of sports, cinema, and the thrill of gaming directly to the living room. It also allows them to remaster or distribute a new type of “Directors Cut” with one to four cameras that were filmed simultaneously during shooting, as well a “Home Directors” version to let viewers decide which angles to watch their favorite old movie or classic sporting event.

It should be understood that the foregoing is illustrative and not limiting, and that obvious modifications may be made by those skilled in the art without departing from the spirit of the invention. Although the invention has been described with reference to embodiments herein, those embodiments do not limit the scope of the invention. Accordingly, reference should be made primarily to the accompanying claims, rather than the foregoing specification, to determine the scope of the invention.

What is claimed is:

1. A projection screen system, comprising:
a frame, the frame having a middle section with first and second sides, a first pivotable section hingedly connected to the first side of the middle section such that the first pivotable section pivots relative to the middle section, and a second pivotable section hingedly connected to the second side of the middle section such that the second pivotable section pivots relative to the middle section;
a screen removably mountable to the frame;
wherein the screen comprises a sheet of polyvinyl chloride;
wherein the screen has a planar shape when the middle, first pivotable, and second pivotable sections of the frame are coplanar and the screen is mounted thereto; and
wherein, when the middle, first pivotable, and second pivotable sections of the frame are coplanar and the screen is mounted thereto, the shape of the screen changes from the planar shape to an arcuate shape when the first and second pivotable sections pivot at an angle relative to the middle section.

2. The projection screen system of claim 1, wherein the screen has a thickness between 30 mils and 60 mils.

3. The projection screen system of claim 1, wherein the frame and the screen have corresponding strips of hook and loop fasteners by which the screen is mountable to the frame.

4. The projection screen system of claim 3, further comprising first and second extension beams each having a back and a front, wherein:
the first pivotable section and the back of the first extension beam have corresponding strips of hook and loop fasteners such the first extension beam is removably mountable to the first pivotable section;
the second pivotable section and the back of the second extension beam have corresponding strips of hook and loop fasteners such the second extension beam is removably mountable to the second pivotable section; and
the screen and the fronts of the first and second extension beams have corresponding hook and loop fasteners such that the screen is removably mountable to the first and second extension beams.

5. The projection screen system of claim 1, wherein the middle section, first pivotable section, and second pivotable section comprise plastic.

6. The projection screen system of claim 1, wherein the middle section, first pivotable section, and second pivotable section comprise polyvinyl chloride.

7. The projection screen system of claim 1, wherein:
each of the first and second pivotable sections of the frame includes a horizontal section;
the frame further comprises a plurality of mounting brackets each having a cavity that accommodates at least a portion of at least one of the horizontal sections such that the mounting bracket is slidable along the horizontal section when the mounting bracket is disposed thereon; and
the screen is mounted to the frame via the plurality of mounting brackets, such that the screen is horizontally slidable relative to the frame when mounted thereto via the plurality of mounting brackets.

8. The projection screen system of claim 7, wherein the screen and the plurality of brackets have corresponding strips of hook and loop fasteners by which the screen is mountable to the plurality of brackets.

9. The projection screen system of claim 1, wherein:
the first pivotable section of the frame includes an upper horizontal beam and a lower horizontal beam;
the frame further comprises a first plurality of mounting brackets each having a cavity that accommodates at least a portion of the upper or lower horizontal beam of the first pivotable section such that the first plurality of mounting brackets are slidable along the upper or lower horizontal beams of the first pivotable section when the first plurality of mounting brackets are disposed thereon;
the second pivotable section of the frame includes an upper horizontal beam and a lower horizontal beam;
the frame further comprises a second plurality of mounting brackets each having a cavity that accommodates at least a portion of the upper or lower horizontal beam of the second pivotable section such that the second plurality of mounting brackets are slidable along the upper or lower horizontal beams of the second pivotable section when the second plurality of mounting brackets are disposed thereon;
the middle section of the frame includes an upper horizontal beam and a lower horizontal beam;
the frame further comprises a third plurality of mounting brackets each having a cavity that accommodates at least a portion of the upper or lower horizontal beam of the middle section such that the third plurality of mounting brackets are slidable along the upper or lower horizontal beams of the third pivotable section when the third plurality of mounting brackets are disposed thereon; and
the screen is mounted to the frame via the first, second, and third pluralities of mounting brackets, such that the screen is horizontally slidable relative to the frame when mounted thereto via the first, second, and third pluralities of mounting brackets.

10. The projection screen system of claim 1, further comprising first and second tripods mounted to the first and second sides of the middle section, respectively, for supporting the frame above a horizontal surface, the first and second tripods each having collapsible legs.

11. The projection screen system of claim 10, wherein each of the first and second tripods includes a vertical member by which the first and second tripods are mounted to the middle section, the vertical member being vertically extendable relative to the legs.

12. The projection screen system of claim 11, wherein vertical members of the first and second tripods are removably mounted to the middle section.

13. The projection screen system of claim 1, further comprising a plurality of mounting beams for mounting the frame to a wall.

14. The projection screen system of claim 1, wherein each of the middle, first pivotable, and second pivotable sections of the frame comprises two horizontal beams and two vertical beams, wherein each of the horizontal beams is connected to each vertical beam via a lap joint.

15. The projection screen system of claim 1, wherein each of the middle, first pivotable, and second pivotable sections of the frame comprises two horizontal beams and two vertical beams, wherein each end of the horizontal beams includes a protuberance, and each end of the vertical beams includes a recess for accommodating one of the protuberances.

16. The projection screen system of claim 1, wherein each of the middle, first pivotable, and second pivotable sections of the frame comprises two horizontal beams and two vertical beams, further comprising a plurality of corner connectors each having perpendicular protuberances, wherein each end of the horizontal and vertical beams includes a recess for accommodating one of the protuberances of the corner connectors.

17. The projection screen system of claim 1, further comprising a reversible bracket having a first side and a second side, wherein:
the middle, first pivotable, and second pivotable sections of the frame each has a front face and a rear face;
the screen is removably mountable to the front faces of the middle, first pivotable, and second pivotable sections of the frame;
the first side of the reversible bracket is substantially flat, such that when the first side of the reversible bracket is attached to the rear face of the middle section and the rear face of one of the first and second pivotable sections, the reversible bracket retains the sections attached thereto in a coplanar alignment; and
the second side of the reversible bracket has a first portion and a second portion angularly offset from the first portion, such that, when the second side of the reversible bracket is attached to the rear face of the middle section and the rear face of one of the first and second pivotable sections, the reversible bracket retains the pivotable section attached thereto at an angle relative to the middle section.

18. The projection screen system of claim 1, further comprising at least one elongated retaining bracket removably attachable to the frame, wherein:
the middle, first pivotable, and second pivotable sections of the frame each has a front face and a rear face;
the screen is removably mountable to the front faces of the middle, first pivotable, and second pivotable sections of the frame; and
the at least one elongated retaining bracket and the tops of the rear faces of the middle, first pivotable, and second pivotable sections of the frame have corresponding hook and loop fasteners by which the at least one elongated retaining bracket is attached to the middle, first pivotable, and second pivotable sections such that, when the at least one elongated retaining bracket is attached to the middle, first pivotable, and second pivotable sections, the elongated retaining bracket retains the middle, first pivotable, and second pivotable sections in a coplanar alignment.

19. The projection screen system of claim 1, further comprising a projector for projecting images on the screen.

20. The projection screen system of claim 19, further comprising a multiviewer that receives data from a plurality of input sources, processes the data, and transmits the data to the projector for simultaneous projection of images reflecting data from the plurality of input sources.
